(19) United States
(12) Patent Application Publication
(10) Pub. No.: US 2004/0203480 A1
(43) Pub. Date: Oct. 14, 2004

(54) Configuration and management of human interface and other attached devices through bi-directional radio frequency link

(76) Inventors: Drew J. Dutton, Austin, TX (US); James R. MacDonald, Buda, TX (US); Stephen Cox, Lakeway, TX (US)

Correspondence Address: Jeffrey C. Hood, Meyertons, Hood, Kivlin, Kowert Goetzel PC, P.O. Box 398, Austin, TX, 78767, US

(21) Appl. No.: 10/410,090

(22) Filed: Apr. 9, 2003

(51) Int. Cl. H04B 1/40

(52) U.S. Cl. 455/74; 455/41.2

(57) ABSTRACT

A system and method for configuring a radio frequency (RF) peripheral device using bi-directional communication. A computer may be coupled to a first radio frequency transmitter/receiver (RFTR). The first RFTR may transmit an RF signal comprising configuration information to a second RFTR in an RF peripheral device. The RF peripheral device may be configured using the configuration information in the RF signal. For example, configuration information such as keymaps, status indicators, and annunciators and other beacon activators may be sent to the RF peripheral device. A status indicator such as a Caps lock indicator, a Num lock indicator, and a Scroll lock indicator may be activated/deactivated. Alternate key layouts may also be activated/deactivated using configuration information. Other configuration information may also be transmitted to and used to configure the RF peripheral device.

### BACKGROUND OF THE INVENTION

1. Field of the Invention

The present invention relates generally to managing peripheral device usage for a computer system and specifically to communication between a computer system and radio frequency peripheral devices.

2. Description of the Related Art

Computer systems may use many different types of peripheral devices including input devices and output devices. Computers may use input devices such as, but not limited to, a pointing device, such as a computer mouse, a keyboard, a microphone, a camera, a gamepad, a touchscreen, and a joystick. For example, a computer mouse may receive input from the user through an X-sensor and a Y-sensor that indirectly displays a user's hand motions. A keyboard may use a micro-processor in the keyboard to coordinate an internal keymap with the location of a pressed key to determine a character pressed by a user. The computer mouse and the keyboard may also have status indicators. For example, the keyboard may have a Caps lock indicator that may be activated to indicate that the Caps lock function is active. Computer systems may also use output devices such as, but not limited to, speakers, displays, and printers.

Because managing wires from different peripheral devices may be cumbersome, the computer may use wireless, e.g., radio frequency (RF), signals to communicate with the peripheral devices. For example, an RF peripheral device such as, but not limited to, RF input devices and RF output devices, may transmit an RF signal to the computer to provide the computer with a user's inputs (e.g., computer mouse movements and keyboard keys pressed) or receive RF signals to provide output (e.g., display data on an RF display).

### SUMMARY OF THE INVENTION

In one embodiment, computer systems may use bi-directional communication to transfer configuration information to an RF peripheral device to configure the RF peripheral device. In one embodiment, the computer system may use a first radio frequency transmitter/receiver (RFTR) to transmit an RF signal comprising the configuration information to a second RFTR in an RF peripheral device. The RF peripheral device may be configured using the configuration information in the RF signal. For example, the configuration information may be related to items such as, but not limited to, keymaps, status indicators, and annunciators and other beacon activators. In one embodiment, the status indicator, such as, but not limited to, a Caps lock indicator, a Num lock indicator, and a Scroll lock indicator, may be activated/deactivated using the configuration information. In one embodiment, alternate key layouts may also be activated/deactivated using configuration information. As another example, configuration information may also be used to activate an annunciator (e.g., a visual beacon or audio beacon) on the RF peripheral device to help locate the RF peripheral device.

In yet another example, configuration information may be used to configure the RF peripheral devices that provide output (e.g., an RF display, an RF speaker, and an RF printer). In one embodiment, bi-directional communication may not be needed to provide configuration information. Other uses of configuration information are also contemplated.

### BRIEF DESCRIPTION OF THE DRAWINGS

A better understanding of the present invention may be obtained when the following detailed description is considered in conjunction with the following drawings, in which:

FIG. 1 illustrates a computer system with an RF peripheral device, according to one embodiment;

FIG. 2 illustrates a block diagram of a computer system and an RF peripheral device, according to one embodiment;

FIG. 3 illustrates a flowchart of a method for configuring an RF peripheral device using RF signals, according to one embodiment;

FIG. 4 illustrates a flowchart of a method for configuring an RF keyboard with a keymap using RF signals, according to one embodiment; and

FIG. 5 illustrates a flowchart of a method for activating a locator beacon in an RF peripheral device, according to one embodiment.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE INVENTION

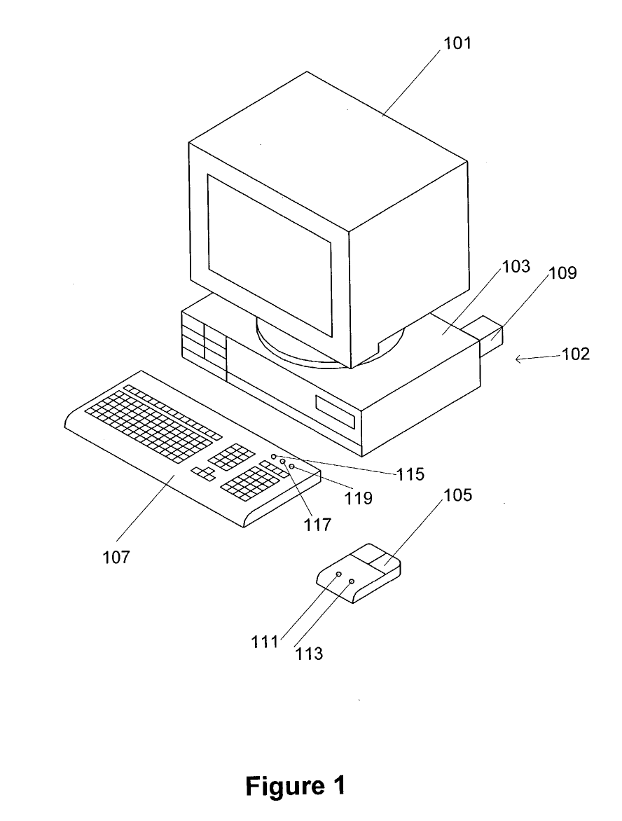

FIG. 1: Computer System with an RF Peripheral Device

FIG. 1 illustrates an embodiment of a computer system with a computer and an RF peripheral device. In various embodiments, the RF peripheral device may be a wireless input device such as, but not limited to, an RF pointing device, such as an RF computer mouse 105, an RF keyboard 107, an RF camera, an RF joystick, an RF gamepad, an RF touchscreen, or an RF microphone. Embodiments of the RF peripheral devices described herein may also be used with wireless output devices, such as an RF speaker, an RF display 101, and an RF printer. Other RF peripheral devices are also contemplated. In one embodiment, a computer 102 may have a processor/memory housing 103. In one embodiment, the computer 102 may communicate with the RF peripheral device through a peripheral base station 109 coupled to the processor/memory housing 103. In various embodiments, the RF peripheral devices may have indicators (e.g., light emitting diodes (LEDs)) such as computer mouse indicators 111 and 113 and keyboard indicators 115, 117, and 119. Other indicators are also contemplated.

In one embodiment, RF signals may be transmitted between the computer 102 and one or more RF peripheral devices. For example, RF computer mouse movements may be transmitted to the computer 102 to control a cursor and keystrokes may be transmitted from the RF keyboard 107 to the computer 102 to provide user typed characters. Other input is also contemplated. As another example, output may be transmitted to the RF display 101 to display an image on the RF display 101. In one embodiment, the computer 102 may communicate with multiple RF peripheral devices on one channel. For example, adjacent computers may each use a separate channel to communicate with the respective computer's RF peripheral devices. Other channel usage is also contemplated. In one embodiment, the RF peripheral device may communicate with the computer 102 through a bit stream relayed by half-duplex communication using a frequency shift keying (FSK) RF link. Other communication forms are also contemplated.

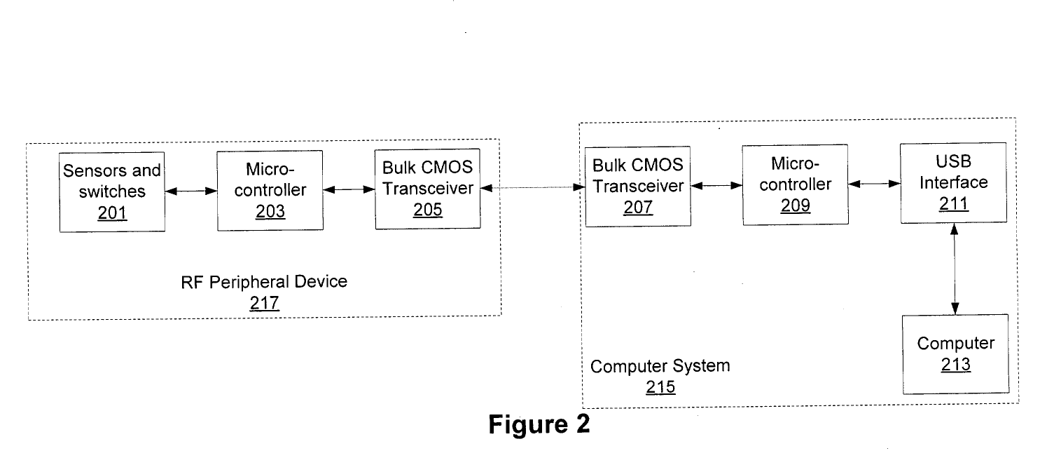

FIG. 2: Block Diagram of a Computer System and an RF Peripheral Device

FIG. 2 illustrates a block diagram of an embodiment of a computer system with an RF peripheral device. The computer system 215 may comprise a computer 213 coupled to a micro-controller 209 through a universal serial bus (USB) interface 211. In one embodiment, the micro-controller 209 may have a micro-processor and a memory with instructions executable by the micro-processor. In one embodiment, a processor, such as a central processing unit (CPU), and a memory, such as a random access memory (RAM) or hard disk memory, may be used in place of the micro-controller 209. Other processors and other memories are also contemplated. The memory may have instructions executable by the processor to control a first radio frequency transmitter/receiver (RFTR) such as, but not limited to, a first bulk complementary metal oxide semiconductor (CMOS) transceiver 207. In one embodiment, the first RFTR and the micro-controller 209 may be located in the peripheral base station 109 (see FIG. 1) coupled to the computer 213 and use modulation and demodulation of RF signals for communication. In one embodiment, the first RFTR and the micro-controller 209 may be located in the processor/memory housing 103.

In one embodiment, the RF peripheral device 217 may have a second RFTR such as, but not limited to, a bulk CMOS transceiver 205 for receiving and transmitting configuration information to the first CMOS transceiver 207 coupled to the computer 213. The second RFTR may be coupled to a micro-controller 203. In one embodiment, the micro-controller 203 may have a micro-processor and a memory with instructions executable by the micro-processor. The RF peripheral device 217 may use various sensors and switches 201 to gather information from the user for transmitting to the computer 213. For example, an RF computer mouse may have an X direction sensor and a Y direction sensor for detecting user input movement. Other sensors and switches are also contemplated. In addition, while the block diagram shows an embodiment with sensors and switches 201, other sources for inputs and outputs are also contemplated.

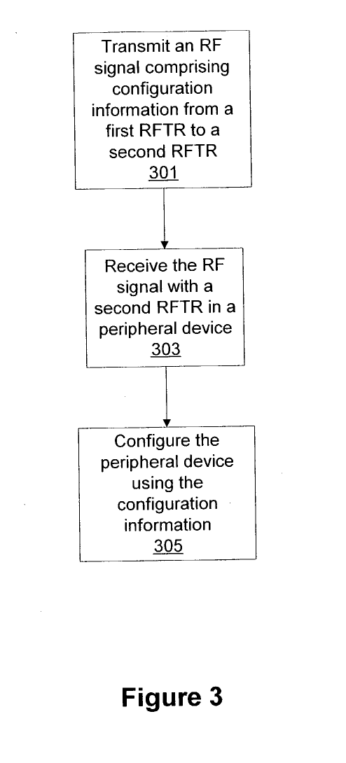

FIG. 3: Flowchart for Configuring an RF Peripheral Device Using RF Signals

FIG. 3 is a flowchart of an embodiment of a method for configuring an RF peripheral device using RF signals. It should be noted that in various embodiments of the methods described below, one or more of the steps described may be performed concurrently, in a different order than shown, or may be omitted entirely. Other additional steps may also be performed as desired.

In 301, an RF signal comprising configuration information may be transmitted from a first RFTR coupled to a computer to a second RFTR in an RF peripheral device. For example, the configuration information such as, but not limited to, keymaps, status indicators, and annunciators and other beacon activators may be sent to the RF peripheral device. In one embodiment, configuration information may include a mouse report rate and keyboard key repeat speed changes. In one embodiment, configuration information may include haptic feedback or force feedback relative to an RF peripheral device's actions. In one embodiment, configuration information may include a device identification (ID) and an identifier for an RF peripheral base station for the RF peripheral device to use in case of signal loss. The configuration information may also include a reunion channel to use in case of signal loss. In one embodiment, if the RF peripheral device is a touch pad, configuration information may include a mode of finger position and motion detection (e.g., relative or absolute). The configuration information may also include information for considering false inputs such as, but not limited to palm rejection while typing.

In one embodiment, frequency restrictions and regulations in various countries may be pre-stored or received by the computer (e.g., using a driver or stored registered location data). The configuration information may include relevant location specific channel restrictions and regulations for the RF peripheral devices to use to be in regulatory compliance. In addition, restricted universal channels may be included in the configuration information.

Other configuration information is also contemplated.

In 303, the RF signal may be received by the second RFTR in the RF peripheral device. After the second RFTR receives the RF signal, the second RFTR may transfer the configuration information in the RF signal to a micro-controller in the RF peripheral device.

In 305, the RF peripheral device may be configured using the configuration information in the RF signal. For example, a status indicator, such as, but not limited to, a Caps lock indicator, a Num lock indicator, and a Scroll lock indicator, may be activated/deactivated using the configuration information. In one embodiment, alternate key layouts may be activated/deactivated using configuration information. For example, in a compressed keyboard format, one set of keys may serve as both letter keys and number pad keys. An RF keyboard may switch the set of keys between the letter keys and the number keys using the configuration information. In another embodiment, configuration information, such as, but not limited to, display settings, may be sent to and used to configure RF peripheral devices for output such as, but not limited to, an RF speaker, an RF display, or an RF printer. In one embodiment, an annunciator may be activated on an RF computer mouse to help locate the RF computer mouse. In yet another embodiment, keymaps may be used to configure the RF keyboard. In one embodiment, bi-directional communication may not be needed to provide configuration information. Other configuration information and other RF peripheral devices are also contemplated.

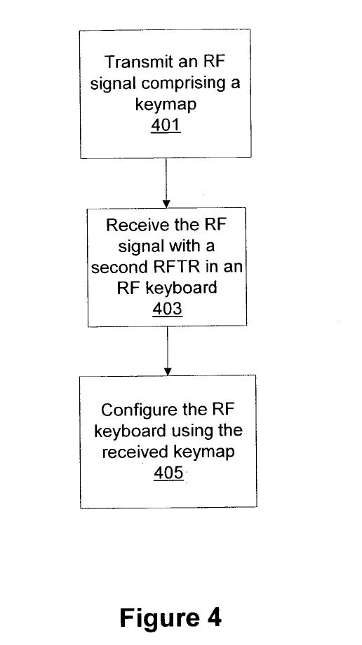

FIG. 4: Flowchart for Configuring an RF Keyboard with a Keymap Using RF Signals

FIG. 4 illustrates a flowchart of an embodiment of a method for configuring an RF keyboard with a keymap using RF signals. It should be noted that in various embodiments of the methods described below, one or more of the steps described may be performed concurrently, in a different order than shown, or may be omitted entirely. Other additional steps may also be performed as desired.

In 401, an RF signal comprising a keymap may be transmitted from a first RFTR to a second RFTR in an RF keyboard. In one embodiment, the keymap may be a map of characters corresponding to the keyboard keys. In one embodiment, the keymaps may be used for language support and point of sale applications. Other uses of the keymaps are also contemplated.

In 403, the RF signal may be received by the second RFTR in the RF keyboard. The second RFTR may transfer the configuration information to the micro-controller in the RF keyboard.

In 405, the RF keyboard may be configured using the received keymap. For example, the micro-controller in the RF keyboard may use the keymap to determine what characters to send to the computer. The micro-controller in the RF keyboard may determine which characters correspond to the keys pressed by a user and then send the corresponding characters to the computer from the second RFTR.

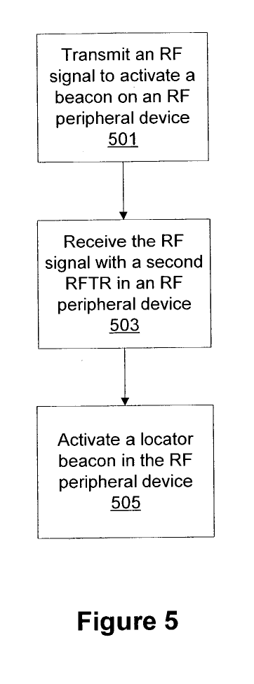

FIG. 5: Flowchart for Activating a Locator Beacon in an RF Peripheral Device

FIG. 5 illustrates a flowchart of an embodiment of a method for activating a locator beacon in an RF peripheral device. It should be noted that in various embodiments of the methods described below, one or more of the steps described may be performed concurrently, in a different order than shown, or may be omitted entirely. Other additional steps may also be performed as desired.

In 501, an RF signal may comprise configuration information to activate a beacon on an RF peripheral device. The RF signal with the configuration information may be transmitted to the second RFTR from the first RFTR.

In 503, the RF signal may be received with the second RFTR in the RF peripheral device. The second RFTR may send the configuration information for the beacon to the micro-controller in the RF peripheral device.

In 505, the beacon in the RF peripheral device may be activated. For example, the micro-controller in the RF peripheral may activate a locator beacon such as, but not limited to, an audio beacon, a light beacon, or a vibrating beacon. For example, if a user of a computer has misplaced the RF peripheral device, such as, but not limited to, an RF computer mouse, the user may have the computer send the configuration information to activate a locator beacon in the RF peripheral device. Other beacons are also contemplated. For example, a beacon may be activated/deactivated (e.g., an LED or lamp) to indicate that the RF peripheral device is active. In another embodiment, the configuration information may be used to activate/deactivate an indicator light or vibrator on the RF peripheral device, such as, but not limited to, an RF computer mouse, to indicate to the user when time deadlines for a presentation have passed (e.g., a five minute presentation mark, a ten minute presentation mark, etc.). Other beacons and beacon functions are also contemplated.

Various embodiments may further include receiving or storing instructions and/or information implemented in accordance with the foregoing description upon a carrier medium. Suitable carrier media may include storage media or memory media such as magnetic or optical media, e.g., disk or CD-ROM, random access memory or other memory, as well as transmission media or RF signals such as electrical, electromagnetic, or digital RF signals, conveyed via a communication medium such as a network and/or a wireless link.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A computer system, comprising:
a processor;
a first radio frequency transmitter/receiver (RFTR); and
an RF peripheral device comprising a second RFTR configured to transmit a radio frequency (RF) signal, wherein the first RFTR and the second RFTR are operable to communicate in a wireless fashion; and
a memory coupled to the processor and configured to store program instructions executable to transmit configuration information for the RF peripheral device from the first RFTR to the second RFTR.

2. The computer system of claim 1,
wherein the RF peripheral device is configured using the configuration information.

3. The computer system of claim 1, further comprising:
a base station for the first RFTR, wherein the base station is coupled to the processor.

4. The computer system of claim 1,
wherein the RF peripheral device is an RF computer mouse, an RF keyboard, an RF touchscreen, an RF gamepad, an RF microphone, an RF joystick, or an RF camera.

5. The computer system of claim 1,
wherein the RF peripheral device is an RF speaker, an RF display, or an RF printer.

6. The computer system of claim 1,
wherein the RF peripheral device is an RF keyboard, and wherein the configuration information is a keymap for the RF keyboard.

7. The computer system of claim 6,
wherein the keymap is used for language support or for a point of sale application.

8. The computer system of claim 1,
wherein the configuration information is used to activate an indicator on the RF peripheral device.

9. The computer system of claim 8,
wherein the indicator is an audio beacon or a visual beacon to aid in locating the RF peripheral device.

10. The computer system of claim 1,
wherein the configuration information is used to activate a status indicator including a Caps lock indicator, a Num lock indicator, a Scroll lock indicator, or an alternate key layout.

11. The computer system of claim 10,
wherein the status indicator comprises a light emitting diode.

12. The computer system of claim 1,
wherein the configuration information is used to activate an indicator on the RF peripheral device to indicate to a user when a time deadline has passed.

13. The computer system of claim 1,
wherein the configuration information is used to cause the RF peripheral device to vibrate.

14. The computer system of claim 1,
wherein the configuration information includes location specific channel restrictions.

15. The computer system of claim 1,
wherein the configuration information includes regulatory information for the RF peripheral device to operate under to be in regulatory compliance.

16. The computer system of claim 1,
wherein the configuration information includes a mouse report rate.

17. The computer system of claim 1,
wherein the configuration information includes a keyboard key repeat speed.

18. The computer system of claim 1,
wherein the configuration information includes feedback regarding RF peripheral device actions.

19. The computer system of claim 1,
wherein the configuration information includes an RF peripheral device identification and a base station identifier.

20. The computer system of claim 1,
wherein the configuration information includes a channel for the RF peripheral device to use in case of signal loss.

21. The computer system of claim 1,
wherein the configuration information includes a mode for an RF peripheral device.

22. The computer system of claim 1,
wherein the configuration information includes information for considering false inputs.

23. A method, comprising:
transmitting an RF signal comprising configuration information from a first RFTR, wherein the first RFTR is coupled to a computer system;
receiving the RF signal from the first RFTR with a second RFTR, wherein the second RFTR is coupled to an RF peripheral device; and
configuring the RF peripheral device according to the configuration information.

24. The method of claim 23,
wherein the RF peripheral device is an RF computer mouse, an RF keyboard, an RF touchscreen, an RF gamepad, an RF microphone, an RF joystick, or an RF camera.

25. The method of claim 23,
wherein the RF peripheral device is an RF speaker, an RF display, or an RF printer.

26. The method of claim 23,
wherein the configuration information comprises a keymap.

27. The method of claim 23,
wherein the configuration information is used to activate an indicator on the RF peripheral device.

28. The method of claim 27,
wherein the indicator is an audio beacon or a visual beacon to aid in locating the RF peripheral device.

29. The method of claim 27,
wherein the indicator includes a Caps lock indicator, a Num lock indicator, a Scroll lock indicator, or an alternate key layout indicator.

30. The method of claim 23,
wherein the configuration information is used to activate an indicator on the RF peripheral device to indicate to a user when a time deadline has passed.

31. The method of claim 23,
wherein the configuration information is used to cause the RF peripheral device to vibrate.

32. The method of claim 23,
wherein the configuration information comprises location specific channel restrictions.

33. The method of claim 23,
wherein the configuration information includes regulatory information for the RF peripheral device to operate under to be in regulatory compliance.

34. A system, comprising:
means for transmitting an RF signal comprising configuration information from a first RFTR, wherein the first RFTR is coupled to a computer system;
means for receiving the RF signal from the first RFTR with a second RFTR, wherein the second RFTR is coupled to an RF peripheral device; and
means for configuring the RF peripheral device according to the configuration information.

35. A carrier medium comprising program instructions, wherein the program instructions are computer executable to:
transmit an RF signal comprising configuration information from a first RFTR, wherein the first RFTR is coupled to a computer system;
receive the RF signal from the first RFTR with a second RFTR, wherein the second RFTR is coupled to an RF peripheral device; and
configure the RF peripheral device according to the configuration information.
